(19) United States
(12) Patent Application Publication
(10) Pub. No.: US 2015/0068561 A1
(43) Pub. Date: Mar. 12, 2015

(54) SYSTEM, METHOD AND APPARATUS FOR PAINT ROLLER CLEANING

(71) Applicants: Franklin Andrew MCCLISH, Milford, CT (US); Aaron Miles Gable, Milford, CT (US)

(72) Inventors: Franklin Andrew MCCLISH, Milford, CT (US); Aaron Miles Gable, Milford, CT (US)

(21) Appl. No.: 14/020,392

(22) Filed: Sep. 6, 2013

(51) Int. Cl. B44D 3/00

(52) U.S. Cl. CPC B44D 3/006
USPC 134/110; 134/138

(57) ABSTRACT

Disclosed is an apparatus and system for cleaning paint rollers. The apparatus may include a container with a top portion, bottom portion, and one or more side portions; wherein the top portion may have a delivery slot formed therethrough to facilitate the delivery of liquid from an exterior environment to the interior of the container. A securing slot may be formed at the intersection between the top portion and the one or more side portions to facilitate the securing of a paint roller within the container. One or more drainage pipes may be disposed on the one or more side portions or the bottom portion to facilitate liquid waste draining from an interior environment to the exterior.

### BACKGROUND

Paint roller cleaning systems are commonly used to rinse and clear paint rollers from any excess paint. Current technologies often require the user to physically remove the paint roller cover from the handle and place it into a tube, or onto a drill, in order to begin the cleaning process. This often results in some paint dripping on to the user's hands and surroundings during the removal and excessive paint splashing during operation. Therefore, it can be desirable to increase the efficiency and reduce splashing onto the user during operation.

### SUMMARY

According to at least one exemplary embodiment, an apparatus for cleaning paint rollers may be disclosed. The apparatus can include a container with a top portion, bottom portion, and one or more side portions, where the top portion may be hingendly securable to the one or more side portions. The top portion of the container may also have a delivery slot formed therethrough. A securing slot may be formed at an intersection between the top portion and the one or more side portions, and one or more clamping mechanisms may be disposed proximate the securing slot to further secure a paint roller a desired distance off the bottom portion of the container. One or more drainage pipes may also be disposed on at least one of the one or more side portions or the bottom portion.

According to at least one exemplary embodiment, a system for cleaning paint rollers may be disclosed. The system can include a container with a top portion, a bottom portion, and one or more side portions, where the top portion may be hingedly securable to the one or more side portions. The top portion of the container may also have a delivery slot formed therethrough to allow for liquid to be delivered from an exterior environment to the interior of the container and onto a paint roller cover disposed within the container. A securing slot may be formed at an intersection between the top portion and the one or more side portions of the container, and one or more clamping mechanisms may be disposed proximate the securing slot to further secure a paint roller a desired distance off the bottom portion of the container. One or more drainage pipes may also be disposed on at least one of the one or more side portions or the bottom portion.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 is an exemplary perspective view of a paint roller cleaning apparatus.

FIG. 2 is an exemplary perspective view of a paint roller cleaning apparatus with top portion open.

FIG. 3 is an exemplary perspective view of a paint roller cleaning apparatus with a paint roller contained within and the top portion open.

FIG. 4 is an exemplary perspective view of a paint roller cleaning apparatus in operation.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

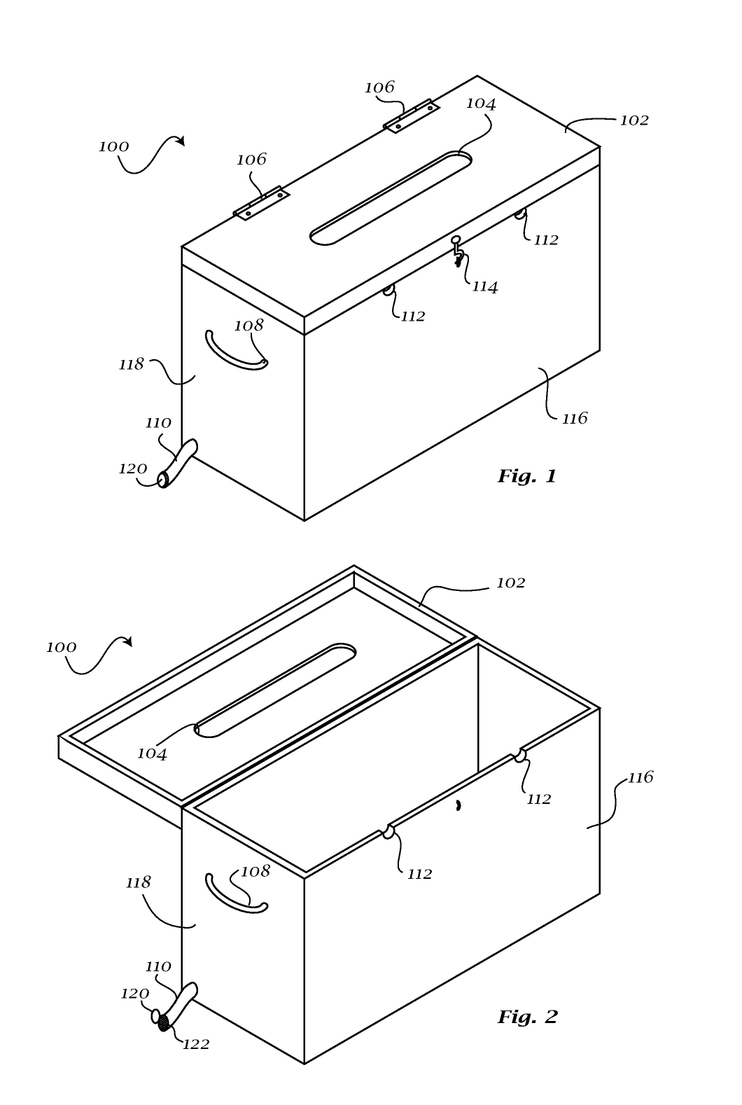

Generally referring to FIGS. 1-5, an apparatus and system to clean paint rollers may be described. In the exemplary embodiments described by the figures, a container may house a paint roller within and under a top portion having an open delivery slot. The paint roller cover may be placed under the open delivery slot, allowing for water or paint cleaners to be sprayed through the delivery slot and onto the paint roller. The top portion could act as a shield for any splattering paint, and the container may hold the excess liquid or waste products. The container may also have a drainage pipe with a cap to facilitate the containing or draining of liquid or waste products.

FIG. 1 shows an exemplary embodiment of a paint roller cleaning device. The device may be a container 100 having a top portion 102 connected to container 100 with hinges 106. Top portion 102 can be made of transparent material, such as glass or a type of plastic, and may have an open delivery slot 104 of any shape, for example a rounded rectangular shape. Delivery slot 104 may be sized such that it can allow for a complete view of an inserted paint roller cover. For example, delivery slot 104 may have a major axis of about 20 inches and a minor axis of about 1.5 inches, or a size as otherwise desired that may accommodate a paint roller within. Container 100 may be made from wood, such as pine, or a similar light-weight composite or plastic material, and may be coated with a waterproofing agent, such as clear acrylic or a similar material, so as to form a substantially watertight seal and to prevent warping or distortion. Additionally, container 100 edges may be sealed with watertight sealants, such as enamel caulk or a similar material.

Still referring to exemplary FIG. 1, container 100 may have a front wall 116 and a side wall 118. Front wall 116 may have a securing mechanism 114, such as a hook latch or similar mechanism, to secure top portion 102 to container 100 in a substantially watertight fashion. A rubber seal or gasket may be formed on the bottom of top portion 102 or the top of open container 100 to facilitate a substantially watertight connection when closed. Side wall 118 may have a handle 108 for carrying and transporting the device, and in other exemplary embodiments, container 100 may have wheels to facilitate transportation. Side wall 118 may also have a drainage pipe 110 proximate the bottom to facilitate the drainage of liquid or other waste products from an interior position to an exterior position of container 100. Drainage pipe 110 may be made of PVC pipe or similar material as desired, and be sized such that it achieves a desirable flow. Drainage pipe 110 may have a removable cap 120 to seal it substantially and allow the liquid or waste product to remain inside container 100, and also may have a filter 122 to allow only liquid or small particulates to drain while keeping larger particulates and waste products within container 100. In other exemplary embodiments, container 100 may have more than one drainage pipe 110 in similar or other locations as desired, such as one or more drainage pipes or holes formed on the bottom portion of container 100, for example.

FIG. 2 shows an exemplary embodiment with top portion 102 in an open position. Securing slot 112 may be exposed when top portion 102 is open, which can allow for the placement of a paint roller within securing slot 112. The interior of container 100 may be substantially hollow to allow for accumulation of liquid or waste products and for placement of a paint roller. In another exemplary embodiment, the bottom of container 100 may have a raised portion to create a slope, which may allow for ease of draining via drainage pipe 110. In yet another exemplary embodiment, a slope may be formed at the bottom of container 100 with an external insert, which can be made of plastic or a similar material, placed onto the floor of container 100 and adhered thereto in a substantially watertight fashion. Alternatively, the bottom of container 100 may be formed in an angular fashion or have a groove or set of grooves to direct liquid waste towards drainage pipe 110.

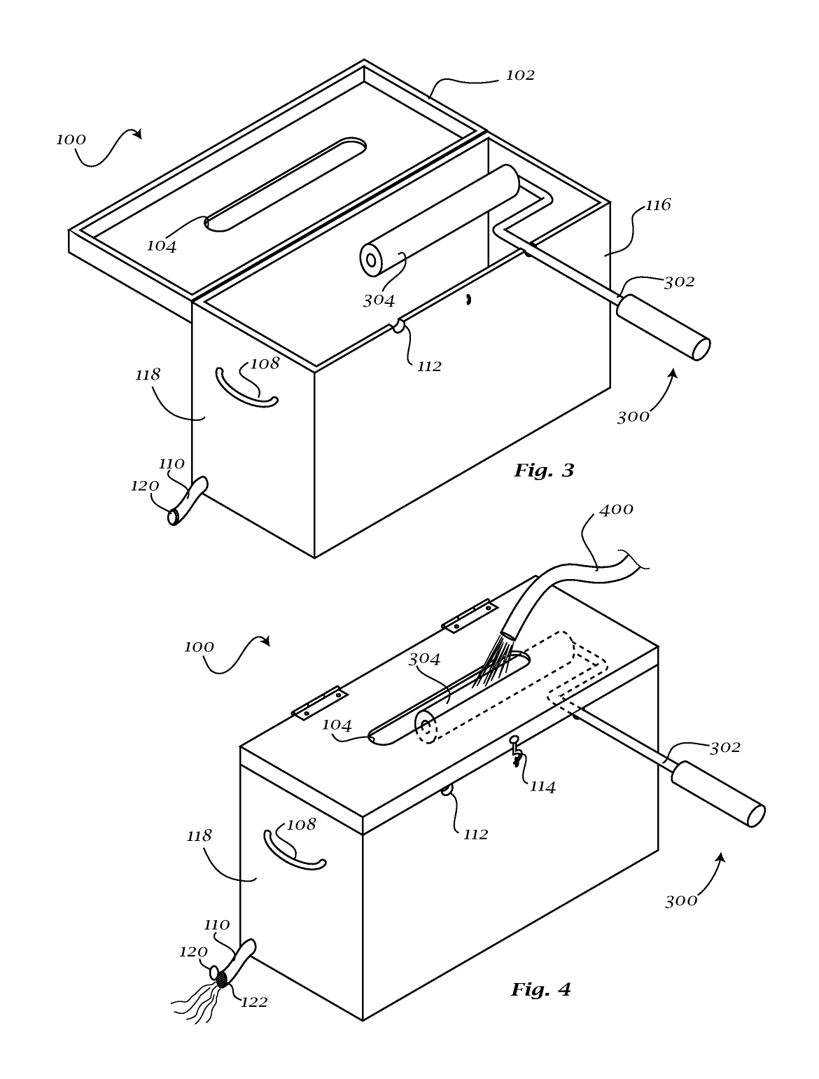

FIG. 3 shows an exemplary embodiment with top portion 102 in an open position and paint roller 300 placed inside container 100. Paint roller handle 304 can rest on securing slot 112 so that paint roller cover 302 is suspended inside at a desired distance off the bottom portion and near the center of container 100 or at another desired position. In a further exemplary embodiment, paint roller 300 may be secured in place with a clamping mechanism.

The clamping mechanism may be, for example a rubber seal that forms a clamp around a handle of paint roller 300 when the container is in a closed position that may hold paint roller with a friction tight grip and position paint roller cover 302 a desired distance off of the bottom portion of container 100. Also one or more clamps, grips, brackets or the like may be utilized. The one or more clamps, grips, brackets or the like could maintain paint roller cover 302 in a suspended position a desired distance off the bottom portion of container 100 either alone or in conjunction with a rubber seal

FIG. 4 shows an exemplary use of container 100. In this example, top portion 102 may be closed and paint roller 300 may be disposed in a cleaning position. Paint roller handle 304 may be resting on securing slot 112, with paint roller cover 302 under delivery slot 104. Securing mechanism 114 may be locked so that the system is substantially watertight. A hose or nozzle 400 may be positioned so that water or other cleaning solutions may flow therethrough and into delivery slot 104. In another exemplary embodiment, hose or nozzle 400 may be fixed to container 100 or removably connected thereto. Emitted stream 402 may impact paint roller cover 302 for rinsing or cleaning purposes. In one exemplary embodiment, paint roller cover 302 may be positioned proximate the rear wall so that a stream 402 normal to the ground would cause paint roller cover 302 to rotate about its handle. Excess liquid may be emitted from drainage pipe 110 when cap 120 is open and drained into a suitable location desirable to the user. In another exemplary embodiment, paint roller 300 may be moved or rotated while impacted by stream 402 to further clean different locations.

Still referring to exemplary FIG. 4, top portion 102 may act as a shield to protect against splashing of paint or liquid waste. As paint roller cover 302 rotates, stream 402 may clean or rinse an entire area while excess liquid and waste may remain fall to bottom floor of container 100. Once at the bottom of container 100, liquid waste may remain contained within container 100 if cap 120 is attached to drainage pipe 110. If cap 120 is not attached to drainage pipe 110, liquid waste may flow within and exit drainage pipe 120 into an exterior environment. In another exemplary embodiment, bottom floor of container 100 may be connected with hinges or a securing mechanism, similar to hinges 106 or securing mechanism 114, so that the floor of the container may be removable, allowing container 100 to be placed in a sink or a similar waste container during operation. In another exemplary embodiment, an exterior of bottom portion of container 100 may be coated with rubber or a similar material to increase friction in order to maintain position with the ground. In yet another exemplary embodiment, container 100 may house a paint brush or other tool with a handle to be cleaned or rinsed in a similar fashion.

Still referring to exemplary FIG. 4, top portion 102 may be removed or kept in an open position so that container 100 and paint roller 300 may dry in ambient temperature. In alternate embodiments, a jet of warm or ambient air may be provided through delivery slot 104 to further accommodate drying.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. An apparatus for cleaning paint rollers, comprising:
a container with a top portion, bottom portion, and one or more side portions, wherein the top portion is hingedly securable to one or more of the side portions;
a delivery slot formed through the top portion of the container;
a securing slot formed at an intersection between the top portion and the one or more side portions;
one or more drainage pipes disposed on at least one of the one or more side portions or the bottom portion; and
one or more clamping mechanisms proximate the securing slot that facilitates suspension of a paint roller being cleaned a desired distance off the bottom portion.

2. The apparatus for cleaning paint rollers of claim 1, wherein the top portion is formed of at least one of plastic, glass, wood, or metal.

3. The apparatus for cleaning paint rollers of claim 1, further comprising of one or more hinges disposed between the top portion and one or more side portions to facilitate the opening of the top portion from the side portions.

4. The apparatus for cleaning paint rollers of claim 1, wherein the one or more drainage pipes are formed of at least one of PVC, plastic, wood, or metal.

5. The apparatus for cleaning paint rollers of claim 1, wherein the drainage pipes include at least one filter.

6. The apparatus for cleaning paint rollers of claim 1, further comprising a substantially watertight seal around the edges of the top portion, one or more side portions, and the bottom portion.

7. The apparatus for cleaning paint rollers of claim 1, wherein the bottom portion of the container is angled toward the one or more drainage pipes.

8. The apparatus for cleaning paint rollers of claim 1, further comprising a securing mechanism that secures the top portion with one or more side portions.

9. The apparatus for cleaning paint rollers of claim 1, further comprising one or more clamping mechanisms proximate the securing slot.

10. A system for cleaning paint rollers, comprising:
a container with a top portion, bottom portion, and one or more side portions, the top portion being hingedly securable to one or more of the side portions;
a delivery slot formed through the top portion of the container;
a securing slot formed between (at the intersection of) the top portion and one or more side portions;
one or more drainage pipes disposed on at least one of the one or more side portions or the bottom portion;
one or more clamping mechanisms proximate the securing slot to facilitate suspension of item being cleaned a desired distance off the bottom portion;
a paint roller having a handle and a cover, where the paint roller is securably positioned above the bottom portion in an interior of the container; and
a liquid delivery source that delivers liquid through the delivery slot on the top portion and onto the paint roller, wherein the excess liquid is drained through the one or more drainage pipes;

11. The system of claim 10, wherein the paint roller cover rotates about the handle when impacted by the liquid.

12. The system of claim 10, wherein a paint roller handle of the paint roller is secured within the securing slot with one or more clamping mechanisms.

13. The system of claim 10, wherein the drainage pipes include at least one filter.

14. The system of claim 13, wherein the excess liquid flows through one or more filters within the one or more drainage pipes.
